(19) United States
(12) Patent Application Publication
(10) Pub. No.: US 2016/0189331 A1
(43) Pub. Date: Jun. 30, 2016

(54) SYSTEM AND METHOD FOR INTER-MODULE COMMUNICATION

(71) Applicant: Tactual Labs Co., New York, NY (US)

(72) Inventors: Ricardo Jorge Jota Costa, Toronto (CA); Myles Gifford, London (CA); Bruno Rodrigues De Araujo, Toronto (CA); Clifton Forlines, Toronto (CA)

(73) Assignee: Tactual Labs Co., New York, NY (US)

(21) Appl. No.: 14/945,009

(22) Filed: Nov. 18, 2015

Related U.S. Application Data
(60) Provisional application No. 62/081,255, filed on Nov. 18, 2014.

(51) Int. Cl. G06T 1/20; G06F 3/041; G06T 1/60

(52) U.S. Cl. CPC G06T 1/20; G06T 1/60; G06F 3/0416; G06T 2200/28

(57) ABSTRACT

Devices and methods are disclosed for utilizing a module running in an operating system to enable communication with decreased latency between a source of input event data and one or more user application processes awaiting input events in a computing device. The module receives a notification that a frame of input event data from a source of input event data is ready to be read. In response, the module reads the frame of input event data from a communication channel such as a named pipe, loads the frame of input event data into a buffer, or into a memory of a dedicated processing unit, and generates a notification to the user application process, thereby causing the user application process to read the frame of input event data from the buffer.

This application is a non-provisional of and claims priority to U.S. Patent Application No. 62/081,255 filed Nov. 18, 2014, the entire disclosure of which is incorporated herein by reference. This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BRIEF DESCRIPTION OF THE DRAWINGS

Objects, features, and advantages of the invention will be apparent from the following description of preferred embodiments as illustrated in the accompanying drawings, in which reference characters refer to the same parts throughout the various views. The drawings are not necessarily to scale, emphasis instead being placed upon illustrating principles of the invention.

FIG. 1 shows a flow diagram illustrating interactions between components of the system both within the existing input event stack and the improved stack using a Touch Processing Unit (TPU).

FIG. 2 shows a flow diagram illustrating implementation of a Kernel Touch Processing Unit (KTPU).

FIG. 3 shows a flow diagram illustrating utilization of the touch processing unit from a user application.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Throughout this disclosure, the terms “touch”, “touches,” “touch event,” “input event,” “contact,” or other descriptors may be used to describe input events or periods of time in which a user's finger, a stylus, an object or a body part is detected by the sensor. In some embodiments, these detections occur only when the user is in physical contact with a sensor, or a device in which it is embodied. In other embodiments, the sensor may be tuned to allow the detection of “touches” or “contacts” that are hovering a distance above the touch surface or otherwise separated from the touch sensitive device. Therefore, the use of language within this description that implies reliance upon sensed physical contact should not be taken to mean that the techniques described apply only to those embodiments; indeed, nearly all, if not all, of what is described herein would apply equally to “touch” and “hover” sensors. As used herein, the phrases “touch event” and “input event,” and the word “touch” when used as a noun, include a near touch and a near touch event, or any other gesture that can be identified using a sensor.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices for inter-module communication. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

Interactive devices are composed of a number of pieces, including sensors that detect user input, computational components that process input, perform actions on data, and generate visual responses, and output devices that output the results of these computations to the user. The pipeline of actions required to convert user input (e.g. finger touches on a touch-screen) into a displayed response is not immediate; each part of the pipeline introduces latency for a number of reasons, such as the time needed to perform calculations on data, the time needed to access additional information required for the correct response, the time needed to pass information from one system component to another, competing processes running on the device, and so on. Improvement to any part of this pipeline can improve the overall latency of the device.

An object of this invention is to enable interactive devices to more quickly respond to user input. In the present invention, we outline how the processing and inter-component communication can be improved in order to more quickly handle incoming user input in an interactive device. By improving these portions of the pipeline, the invention allows for more responsive interactive devices, a highly desirable goal.

The focus of this disclosure is the communication between the processes responsible for the capture of hardware state and the processes responsible for the dissemination of such information upstream to the operating system, user applications, etc. This workflow contains many parts, from event reading, event generation, notification to processes, registration of processes that are interested in being notified, storing of information into shared memory (file, ram, pipes, etc.), reading events from the shared memory by notified process, unregistering of process, and other components.

One of the components of this invention is the Kernel Touch Process Unit (KTPU). In an embodiment, this is a module that interacts with both a sensor driver producing input events (e.g., touch events), and the user applications waiting to receive this touch data. Other modules, such as the evDev have previously been responsible for this functionality, but they typically structure events in a text protocol. The KTPU is not human readable and is intended to “stream” events as fast as possible. One possible procedure for receiving events from the KTPU involves a userland application registering the process expecting input events (e.g., touch events) with the module, and reading events from a communication channel (a named pipe, file, memory, or socket). The application can either poll for events from the file, or register a signal handler and read the events upon receiving a notification.

Initializing Processes that Receive Events

In an embodiment, when a user process initializes, it first registers a signal handler in order to perform some sort of processing after being notified that input events are ready to be read. A user process needs to give some way to identify itself as a target for notification from the module. There are a number of ways to do this. In an embodiment, a user process interested in receiving input events creates a structure that contains a Process ID (PID), and a flag that states that it is ready to receive events, and writes this structure into a file at a known location. In other embodiments, the file may contain a single PID structure (resulting in a single user process receiving events) or multiple PID structures (resulting in multiple processes receiving events, potentially multiplexed between them). In other embodiments the communication channel (e.g., named pipe) is not in a known location and is returned as a result of the initial communication between the process and the module.

In the case of multiple processes receiving events, an embodiment of the invention would include a queue or similar collection for storing information of processes that register to receive events. In another embodiment multiple processes can be registered, but only receive notification events when the process is executing in the foreground, or has the focus of the user.

Another embodiment may utilize notifications (e.g., interrupts, messages, or any other electronic signals that serve to notify) to notify a process. This embodiment would include the signal number, that a process is expecting to receive, in the data being sent during process registration. This may be beneficial from the user's perspective, as signal handling can be application-specific, and a number of signals may already be handled by the application. This may also be extended to include registration that avoids sending notifications to a process, but still notifies the kernel that there are applications polling the module to consume the touch events being produced.

Once the process has been successfully registered to receive events, signals should be sent to the device whenever the KTPU receives an event. Currently, as the events are being generated in the same module at a fixed period, the events' association with a process comes from the user process registering to receive information. In an embodiment, multiple processes can be assigned to receive event notifications. This could be done by storing the association between each pixel or touch point and a given identifier for the process to be notified in another process (or kernel module).

In an embodiment, after receiving a notification, the information relating to the recently generated event is stored in a RAM-based file (such as, for example, a debugfs file) at a known location. The process is expected to have an open file descriptor to the file, read the header from the file, extract the length of data to read from the header, and then read the event data body from the file. All of this may be done before the next event is generated to avoid the buildup of old events. In other embodiments, the parsing of the information can be executed with techniques known to the developer of common skill.

Data Structure Format and File Locations

Any data structure that encapsulates the required information in an event is potentially compatible with our invention. In an embodiment, the structure of the event data is split up into a header and a body.

The header can consist of the following fields:

Timestamp—The system time at which the frame of events was generated. It stores the runtime of the system in a seconds field and a nanoseconds field, the order of which is specified in the timespec struct definition given in the kernel.

Type—The type of frame being sent at the moment.

Length—The length of the message in bytes.

The body of an event data message can consist of a complete frame of some number of touch events. Each touch event currently consists of the following fields, in order of increasing address:

X—The signed x position of the touch event

Y—The signed y position of the touch event

ID—A numeric ID included to keep track of which touch is which (compare slots)

Other embodiments may include the following information:
Touch size
Absolute vs. relative positioning
Touch path velocity
Touch path curvature
Pressure (etc.)
shape of touch
size of touch
rotation of touch
source of touch (e.g. ‘user A’, ‘user B’, ‘stylus#12885’, ‘user C's left hand’, ‘user D's index finger’, etc.)
azimuth of touch

In an embodiment, the process registration information contains the following fields:
Process ID (4 B)—The PID of the process that has registered to receive data from the program
Flags (4 B)—A bitmask of flags regarding the expected operation of the module. The flags follow the following pattern:
   Bits 31-1 (MSB): Unused
   Bit 0 (LSB): Enable notification
   Bit 0 (LSB): Enable notification

Initialization

In an embodiment, the signal or other notification sent to the user process uses the POSIX real-time signal value “SIGRTMIN”, a value which should always be application-defined, and therefore suited for the needs of this project. Other embodiments may use different signals/notifications. The implementation of a signal handler is currently the responsibility of the application developer, who should create a short function that notifies the application logic that data is ready, and to begin reading the new event frame from the event file.

When a process writes a given length of data to the file, if that length is longer than a registration info structure, the write operation returns a −EIO error code. Writing shorter lengths of data should result in that data being copied to the circular buffer at the current write position. Once the data has been copied to the buffer, the updated contents of the buffer are loaded into the kernel variable storing the data of the process to be notified. It is assumed that the writing of registration data is atomic. It is expected that all writes performed on this file will add up to a multiple of the registration structure size. If this is not the case, then the data in the structure will be misaligned and likely corrupted.

Event Generation and Module Notification

Once the KTPU module is notified of a touch event from a source (either an internal generator or a sensor driver), it should load the event into a circular buffer, overwriting the oldest events in the buffer if there is not enough free space. Once the event has been written to the circular buffer, the notification thread will send a POSIX signal with a value of RTSIGMIN to the process with the ID currently being stored.

Reading Touch Events

When a notification is passed to the application, an event should be stored inside of the buffer. The user application is expected to read the header from a known file location that points to the buffer in memory.

In an embodiment, the first thing being read out of the buffer is the event's header, which is of a fixed, known length. This header contains the length of the body, which immediately follows the header in the buffer. This can be obtained through another read to the file with the length obtained from the header. As each touch event is of a fixed size, the total length is be some multiple of that size. In this embodiment it is assumed that having a single producer is sufficient. This creates a need for well-ordered behavior in user applications using the module. In other embodiments, multiple producers require a multi-threaded safe implementation.

Deinitialization/Deregistration

In order to ensure that the module can close properly, it may be important to close each file handle once an application no longer reads or writes to the file. It may also be important to reset the enable flag in the process registration file, and optionally reset the PID contained in the file to 0. This should cause the event buffer to be cleared, in order to prepare for the next process' registration.

Input-to-GPU Variation of the Invention

In another embodiment, the user process that is responsible for the consumption of events resides inside a dedicated processing unit, for example a GPU. In this embodiment, the data goes directly from the kernel space to GPU memory. In other embodiments, the information is first passed to a user space process and only then is sent to a dedicated processing unit.

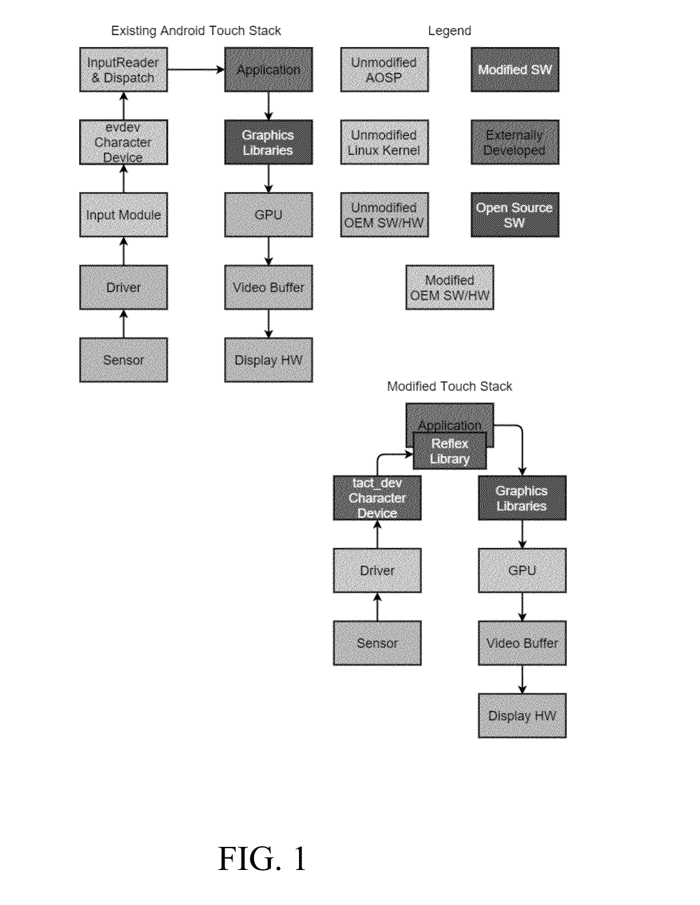

FIG. 1 shows a summary of the interactions between components both within the existing touch event stack and the improved stack using a Touch Processing Unit (TPU). Other approaches to touch processing units are described, e.g., in U.S. patent application Ser. No. 14/046,819 filed Oct. 4, 2013 entitled “Hybrid Systems And Methods For Low-Latency User Input Processing And Feedback,” U.S. patent application Ser. No. 13/841,436 filed Mar. 15, 2013 entitled “Low-Latency Touch Sensitive Device,” U.S. Patent Application No. 61/798,948 filed Mar. 15, 2013 entitled “Fast Multi-Touch Stylus,” U.S. Patent Application No. 61/799,035 filed Mar. 15, 2013 entitled “Fast Multi-Touch Sensor With User-Identification Techniques,” U.S. Patent Application No. 61/798,828 filed Mar. 15, 2013 entitled “Fast Multi-Touch Noise Reduction,” U.S. Patent Application No. 61/798,708 filed Mar. 15, 2013 entitled “Active Optical Stylus,” U.S. Patent Application No. 61/710,256 filed Oct. 5, 2012 entitled “Hybrid Systems And Methods For Low-Latency User Input Processing And Feedback,” U.S. Patent Application No. 61/845,892 filed Jul. 12, 2013 entitled “Fast Multi-Touch Post Processing,” U.S. Patent Application No. 61/845,879 filed Jul. 12, 2013 entitled “Reducing Control Response Latency With Defined Cross-Control Behavior,” U.S. Patent Application No. 61/879,245 filed Sep. 18, 2013 entitled “Systems And Methods For Providing Response To User Input Using Information About State Changes And Predicting Future User Input,” U.S. Patent Application No. 61/880,887 filed Sep. 21, 2013 entitled “Systems And Methods For Providing Response To User Input Using Information About State Changes And Predicting Future User Input,” U.S. patent application Ser. No. 14/046,823 filed Oct. 4, 2013 entitled “Hybrid Systems And Methods For Low-Latency User Input Processing And Feedback,” U.S. patent application Ser. No. 14/069,609 filed Nov. 1, 2013 entitled “Fast Multi-Touch Post Processing,” and U.S. Patent Application No. 61/887,615 filed Oct. 7, 2013 entitled “Touch And Stylus Latency Testing Apparatus.” The entire disclosures of those applications are incorporated herein by reference.

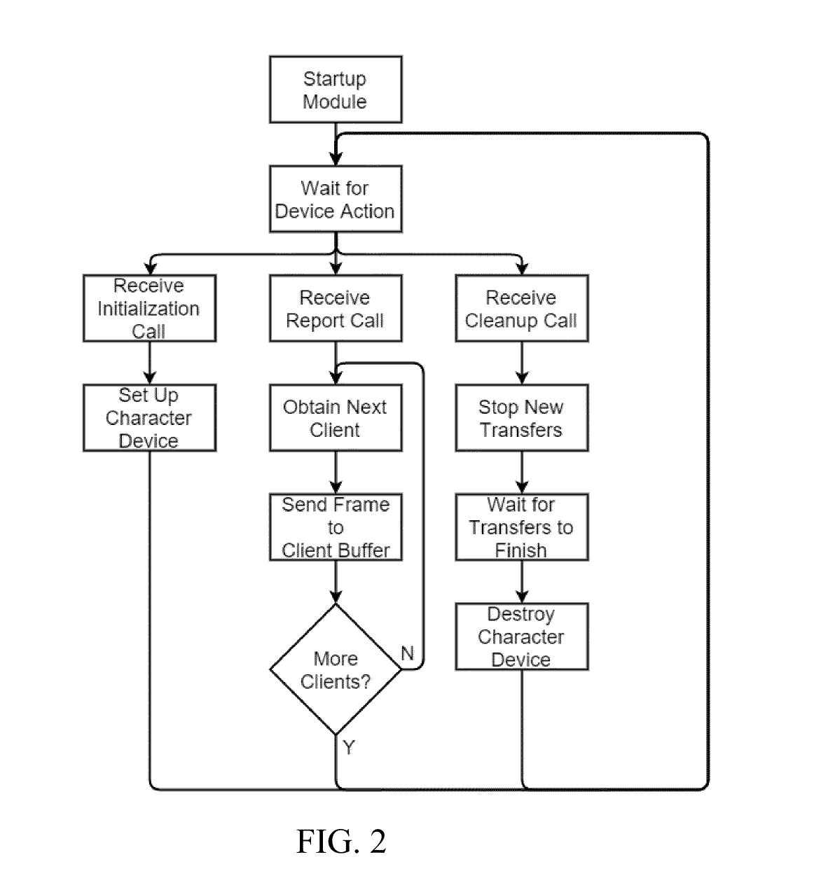

FIG. 2 shows a summary of implementation of a Kernel Touch Processing Unit (KTPU).

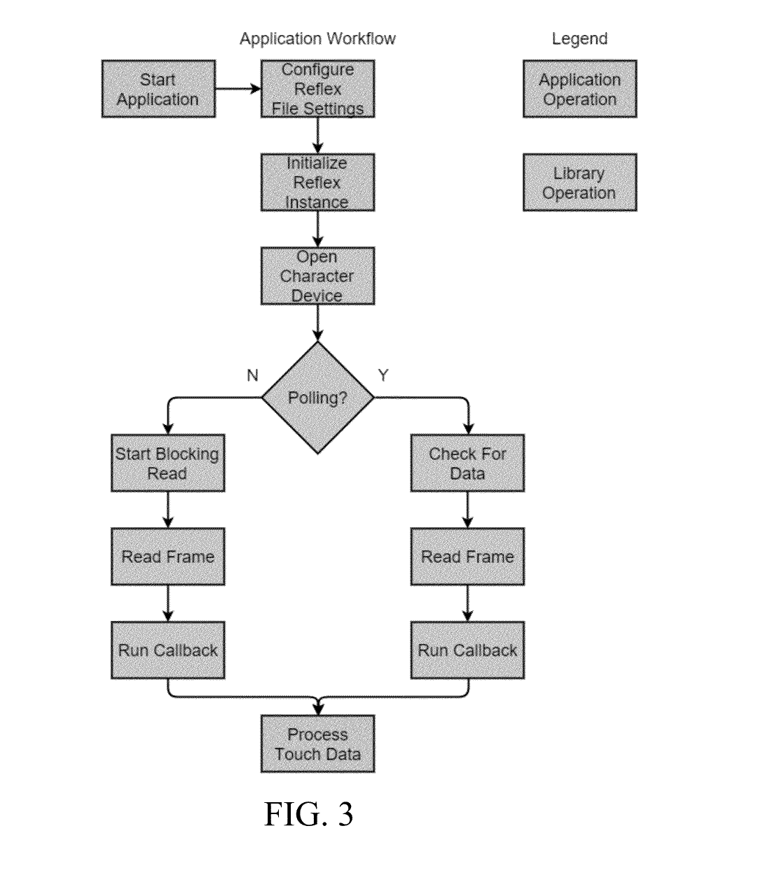

FIG. 3 shows the utilization of the touch processing unit from a user application.

In an embodiment, a frame-based device and method are provided for utilizing a module running in an operating system to enable communication with decreased latency between a source of input event data and one or more user application processes awaiting input events in a computing device. A user application process awaiting input events is registered with the module running in the operating system, thereby identifying the user application process as a target for notification from the module. The module receives a notification indicating that a frame of input event data from a source of input event data is ready to be read. In response, it reads the frame of input event data from a communication channel, uses the module to load the frame of input event data into a buffer, and generates a notification to the user application process, thereby causing the user application process to read the frame of input event data from the buffer.

In another embodiment, a frame-based device and method are provided for utilizing a module running in an operating system to enable communication with decreased latency between a source of input event data and a process awaiting input events running in a dedicated processing unit in a computing device. A user application process awaiting input events is registered with the module running in the operating system, thereby identifying the user application process as a target for notification from the module. The module receives a notification that a frame of input event data from a source of input event data is ready to be read. In response, the module reads the frame of input event data from a communication channel, loads the frame of input event data into a memory associated with a dedicated processing unit, and generates a notification to the user application process, thereby causing the user application process to read the frame of input event data from the memory associated with the dedicated processing unit.

In another embodiment, a frame-based device and method are provided for utilizing a module running in an operating system to enable communication with decreased latency between a source of input event data and a process awaiting input events running in a dedicated processing unit in a computing device. The module polls for an indication that a frame of input event data from a source of input event data is ready to be read. Upon receiving such indication, the module reads the frame of input event data from a named pipe, loads the frame of input event data into a buffer, and generates a notification to the user application process, thereby causing the user application process to read the frame of input event data from the buffer.

At least some aspects disclosed herein can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention as defined in the following claims. For example, elements and/or steps described above and/or in the following claims in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

1. A frame-based method for utilizing a module running in an operating system to enable communication with decreased latency between a source of input event data and one or more user application processes awaiting input events in a computing device, comprising:
registering a user application process awaiting input events with the module running in the operating system, thereby identifying the user application process as a target for notification from the module;
receiving, in the module, a notification that a frame of input event data from a source of input event data is ready to be read;
using the module to read the frame of input event data from a communication channel;
using the module to load the frame of input event data into a buffer; and,
generating, in the module, a notification to the user application process, thereby causing the user application process to read the frame of input event data from the buffer.

2. The method of claim 1, wherein the source of input event data comprises a sensor driver.

3. The method of claim 1, wherein the source of input event data comprises an internal generator.

4. The method of claim 1, wherein the user application process sends at least a portion of the frame of input event data to a dedicated processing unit for processing.

5. The method of claim 4, wherein the dedicated processing unit comprises a graphics processing unit.

6. The method of claim 1, wherein the module running in the operating system is a module running in a userland portion of the operating system.

7. The method of claim 1, wherein the module running in the operating system is a module running in a kernel portion of the operating system.

8. The method of claim 1, wherein the step of using the module to load the frame of input event data into the buffer comprises storing the frame of input event data in a ram-based file at a known location.

9. The method of claim 1, wherein the step of using the module to load the frame of input event data into the buffer comprises storing the frame of input event data as part of a data structure comprising a header and a body.

10. The method of claim 9, wherein the body comprises an X position of an input event, a Y position of the input event, and a unique identifier identifying the input event with which the input event data is associated.

11. The method of claim 9, wherein the body comprises at least one data type selected from the group consisting of: touch size, absolute vs. relative positioning, touch path velocity, touch path curvature, pressure, shape of touch, size of touch, rotation of touch, source of touch, and azimuth of touch.

12. The method of claim 9, wherein the header comprises a timestamp.

13. The method of claim 9, wherein the header comprises a field indicating a length of the body in bytes.

14. The method of claim 13, wherein the application process reads the frame of input event data from the buffer by:
reading the header;
extracting from the header the length of the body in bytes; and,
reading the frame of input event data based on the extracted length of the body.

15. The method of claim 1, wherein the step of registering a user application process awaiting input events comprises registering information comprising a process identifier, the process identifier uniquely identifying the user application process.

16. The method of claim 1, wherein the step of registering a user application process awaiting input events comprises registering information comprising a bitmask of flags associated with expected operation of the module.

17. The method of claim 1, wherein the communication channel comprises a named pipe.

18. The method of claim 1, wherein the communication channel comprises a file.

19. The method of claim 1, wherein the communication channel comprises a memory location.

20. The method of claim 1, wherein the communication channel comprises a socket.

21. A frame-based method for utilizing a module running in an operating system to enable communication with decreased latency between a source of input event data and a process awaiting input events running in a dedicated processing unit in a computing device, comprising:
registering a user application process awaiting input events with the module running in the operating system, thereby identifying the user application process as a target for notification from the module;
receiving, in the module, a notification that a frame of input event data from a source of input event data is ready to be read;
using the module to read the frame of input event data from a communication channel;
using the module to load the frame of input event data into a memory associated with a dedicated processing unit; and,
generating, in the module, a notification to the user application process, thereby causing the user application process to read the frame of input event data from the memory associated with the dedicated processing unit.

22. The method of claim 21, wherein the dedicated processing unit comprises a graphics processing unit.

23. The method of claim 21, wherein the source of input event data comprises a sensor driver.

24. The method of claim 21, wherein the source of input event data comprises an internal generator.

25. The method of claim 21, wherein the user application process sends at least a portion of the frame of input event data to a dedicated processing unit for processing.

26. The method of claim 25, wherein the dedicated processing unit comprises a graphics processing unit.

27. The method of claim 21, wherein the process running in the operating system is a process running in a userland portion of the operating system.

28. The method of claim 21, wherein the process running in the operating system is a process running in a kernel portion of the operating system.

29. The method of claim 21, wherein the step of using the module to load the frame of input event data into the memory comprises storing the frame of input event data in a ram-based file at a known location.

30. The method of claim 21, wherein the step of using the module to load the frame of input event data into the memory comprises storing the frame of input event data as part of a data structure comprising a header and a body.

31. The method of claim 30, wherein the body comprises an X position of an input event, a Y position of the input event, and a unique identifier identifying the input event with which the input event data is associated.

32. The method of claim 30, wherein the body comprises at least one data type selected from the group consisting of: touch size, absolute vs. relative positioning, touch path velocity, touch path curvature, pressure, shape of touch, size of touch, rotation of touch, source of touch, and azimuth of touch.

33. The method of claim 30, wherein the header comprises a timestamp.

34. The method of claim 30, wherein the header comprises a field indicating a length of the body in bytes.

35. The method of claim 30, wherein the application process reads the frame of input event data from the memory by:
reading the header;
extracting from the header the length of the body in bytes; and,
reading the frame of input event data based on the extracted length of the body.

36. The method of claim 21, wherein the step of registering a user application process awaiting input events comprises registering information comprising a process identifier, the process identifier uniquely identifying the user application process.

37. The method of claim 21, wherein the step of registering a user application process awaiting input events comprises registering information comprising a bitmask of flags associated with expected operation of the module.

38. The method of claim 21, wherein the communication channel comprises a named pipe.

39. The method of claim 21, wherein the communication channel comprises a file.

40. The method of claim 21, wherein the communication channel comprises a memory location.

41. The method of claim 21, wherein the communication channel comprises a socket.

42. A frame-based method for utilizing a module running in an operating system to enable communication with decreased latency between a source of input event data and one or more user application processes awaiting input events in a computing device, comprising:
using the module to poll for an indication that a frame of input event data from a source of input event data is ready to be read;
using the module to read the frame of input event data from a named pipe;
using the module to load the frame of input event data into a buffer; and,
generating, in the module, a notification to the user application process, thereby causing the user application process to read the frame of input event data from the buffer.

43. The method of claim 42, wherein the source of input event data comprises a sensor driver.

44. The method of claim 42, wherein the source of input event data comprises an internal generator.

45. The method of claim 42, wherein the user application process sends at least a portion of the frame of input event data to a dedicated processing unit for processing.

46. The method of claim 42, wherein the dedicated processing unit comprises a graphics processing unit.

47. The method of claim 42, wherein the module running in the operating system is a module running in a userland portion of the operating system.

48. The method of claim 42, wherein the module running in the operating system is a module running in a kernel portion of the operating system.

49. The method of claim 42, wherein the step of using the module to load the frame of input event data into the buffer comprises storing the frame of input event data in a ram-based file at a known location.

50. The method of claim 42, wherein the step of using the module to load the frame of input event data into the buffer comprises storing the frame of input event data as part of a data structure comprising a header and a body.

51. The method of claim 50, wherein the body comprises an X position of an input event, a Y position of the input event, and a unique identifier identifying the input event with which the input event data is associated.

52. The method of claim 50, wherein the body comprises at least one data type selected from the group consisting of: touch size, absolute vs. relative positioning, touch path velocity, touch path curvature, pressure, shape of touch, size of touch, rotation of touch, source of touch, and azimuth of touch.

53. The method of claim 50, wherein the header comprises a timestamp.

54. The method of claim 50, wherein the header comprises a field indicating a length of the body in bytes.

55. The method of claim 54, wherein the application process reads the frame of input event data from the buffer by:
reading the header;
extracting from the header the length of the body in bytes; and,
reading the frame of input event data based on the extracted length of the body.

56. The method of claim 42, wherein the communication channel comprises a named pipe.

57. The method of claim 42, wherein the communication channel comprises a file.

58. The method of claim 42, wherein the communication channel comprises a memory location.

59. The method of claim 42, wherein the communication channel comprises a socket.

60. A frame-based method for utilizing a module running in an operating system to enable communication with decreased latency between a source of input event data and a process awaiting input events running in a dedicated processing unit in a computing device, comprising:
using the module to poll for an indication that a frame of input event data from a source of input event data is ready to be read;
using the module to read the frame of input event data from a named pipe;
using the module to load the frame of input event data into a memory associated with a dedicated processing unit; and,
generating, in the module, a notification to the user application process, thereby causing the user application process to read the frame of input event data from the memory associated with the dedicated processing unit.

61. The method of claim 60, wherein the source of input event data comprises a sensor driver.

62. The method of claim 60, wherein the source of input event data comprises an internal generator.

63. The method of claim 60, wherein the user application process sends at least a portion of the frame of input event data to a dedicated processing unit for processing.

64. The method of claim 60, wherein the dedicated processing unit comprises a graphics processing unit.

65. The method of claim 60, wherein the module running in the operating system is a module running in a userland portion of the operating system.

66. The method of claim 60, wherein the module running in the operating system is a module running in a kernel portion of the operating system.

67. The method of claim 60, wherein the step of using the module to load the frame of input event data into the memory comprises storing the frame of input event data in a ram-based file at a known location.

68. The method of claim 60, wherein the step of using the module to load the frame of input event data into the memory comprises storing the frame of input event data as part of a data structure comprising a header and a body.

69. The method of claim 68, wherein the body comprises an X position of an input event, a Y position of the input event, and a unique identifier identifying the input event with which the input event data is associated.

70. The method of claim 68, wherein the body comprises at least one data type selected from the group consisting of: touch size, absolute vs. relative positioning, touch path velocity, touch path curvature, pressure, shape of touch, size of touch, rotation of touch, source of touch, and azimuth of touch.

71. The method of claim 68, wherein the header comprises a timestamp.

72. The method of claim 68, wherein the header comprises a field indicating a length of the body in bytes.

73. The method of claim 72, wherein the application process reads the frame of input event data from the memory by:
reading the header;
extracting from the header the length of the body in bytes; and,
reading the frame of input event data based on the extracted length of the body.

74. The method of claim 60, wherein the communication channel comprises a named pipe.

75. The method of claim 60, wherein the communication channel comprises a file.

76. The method of claim 60, wherein the communication channel comprises a memory location.

77. The method of claim 60, wherein the communication channel comprises a socket.

78. A low-latency touch sensitive device comprising:
a touch sensor capable of sensing location of a finger or object with respect to a touch surface and creating data representative of current user input to the electronic device;
a processor configured to:
i) register a user application process awaiting input events with a module running in an operating system, thereby identifying the user application process as a target for notification from the module;
ii) receive, in the module, a notification that a frame of input event data from a source of input event data is ready to be read;
iii) use the module to read the frame of input event data from a named pipe;
iv) use the module to load the frame of input event data into a buffer; and,
v) generate, in the module, a notification to the user application process, thereby causing the user application process to read the frame of input event data from the buffer.

79. A low-latency touch sensitive device comprising:
a touch sensor capable of sensing location of a finger or object with respect to a touch surface and creating data representative of current user input to the electronic device;
a processor configured to:
vi) register a user application process awaiting input events with the module running in the operating system, thereby identifying the user application process as a target for notification from the module;
vii) receive, in the module, a notification that a frame of input event data from a source of input event data is ready to be read;
viii) use the module to read the frame of input event data from a named pipe;
ix) use the module to load the frame of input event data into a memory associated with a dedicated processing unit; and,
x) generate, in the module, a notification to the user application process, thereby causing the user application process to read the frame of input event data from the memory associated with a dedicated processing unit.
